(19) United States
(12) Patent Application Publication
(10) Pub. No.: US 2026/0160895 A1
(43) Pub. Date: Jun. 11, 2026

(54) METHOD AND TERMINAL FOR SATELLITE GEOPOSITIONING, ASSOCIATED COMPUTER PROGRAM

(71) Applicant: THALES, Meudon (FR)

(72) Inventors: Nicolas MARTIN, VALENCE CEDEX (FR); Denis BOUVET, VALENCE CEDEX (FR); Alexandre ARNAUDON, VALENCE CEDEX (FR)

(21) Appl. No.: 19/409,267

(22) Filed: Dec. 4, 2025

(30) Foreign Application Priority Data
Dec. 5, 2024 (FR) FR2413509

(51) Int. Cl. G01S 19/07; G01S 19/39

(52) U.S. Cl. CPC G01S 19/072; G01S 19/393

(57) ABSTRACT

A method for geopositioning by N satellites emitting electromagnetic signals formed of a carrier frequency modulated by a spreading code, on two frequencies Fa, Fb, including: nominal mode calculation of four pseudo-ranges, a pseudo-range being calculated from each element from among the two codes and the two received carriers; and Kalman filtering the measurement vector of which comprises the four pseudo-ranges and the state vector comprises a smoothed pseudo-range, according to which the propagation and recalibration steps are also carried out on a fictitious state vector as a function of a fictitious measurement vector including constant values.

### CROSS-REFERENCE TO RELATED APPLICATIONS

This application is a U.S. non-provisional application claiming the benefit of French Application No. 24 13509, filed on Dec. 5, 2024, which is incorporated herein by reference in its entirety.

### FIELD

This invention relates to the field of satellite positioning. More specifically, the invention relates to a method for satellite geopositioning and an associated receiver.

### BACKGROUND

A satellite positioning system (or GNSS for Global Navigation Satellite System in Anglo-Saxon terminology) uses a constellation of satellites orbiting the Earth on very precisely determined orbits, in other words, it is possible to know their position at any time. The satellite orbits are chosen so that at any hour, six to twelve satellites are visible from any point on Earth. Each dual-frequency type satellite emits electromagnetic geopositioning signals on two different frequencies (for example, L₁=1,575.42 MHz and L₂=1,227.6 MHz for the GPS system and L₁=1,575.42 MHz and E₅=1,227.6 MHz for the GALILEO system). Dual-frequency satellite measurements allow to correct the ionospheric delay by 99%, which constitutes the predominant source of error.

A GNSS receiver, for example, embedded in a mobile device, receives signals emitted by visible satellites and measures the propagation time required for a timestamp transmitted by a satellite to reach it. The timestamps are coded on carrier waves using phase modulation techniques. Each satellite transmits a unique pseudo-random code. A replica of the code sequence is generated by the receiver, and the shift required in order for the replica to coincide with the received code corresponds to the signal propagation time to cover the satellite-receiver distance. This duration multiplied by the speed of light in the transmission medium gives a distance measurement called pseudo-range. From the pseudo-range measurements separating it from each visible satellite, and knowing the positions of the satellites, the receiver deduces its precise position in latitude, longitude, and altitude in a terrestrial reference frame through a numerical position resolution step similar to triangulation. It can also deduce the precise date and time in the GNSS system time frame.

The receiver time reference, provided by its clock, does not perfectly coincide with the constellation satellites time reference, which induces a bias in the propagation time measurements, therefore in distance, equal to the delay of the receiver time reference relative to the satellites time reference. This is referred to as pseudo-range. The clock time bias, common to all measurements, constitutes a fourth unknown, in addition to the three position unknowns, which require having at least four measurements to calculate the position.

Furthermore, the receiver position is estimated by making several approximations. The pseudo-range measurement cannot, for example, be free from system-related errors such as the lack of precision in ephemerides or the clocks embedded in the satellites. The pseudo-range measurement is also affected by errors related to interactions between signals and atmospheric layers (troposphere and ionosphere) they pass through. The signal propagation delay in the troposphere and ionosphere depends on the inclination of the path and the time at which it occurs. Typically, GNSS positioning errors related to the atmosphere are more pronounced during the day than at night and more sensitive when a satellite is near the horizon than at the zenith. In some applications, such as precision approach in aeronautics, the positioning accuracy obtained by a direct or absolute pseudo-range measurement is not sufficient.

To improve positioning accuracy, receivers can also take advantage of a second piece of information developed by the receiver, which is the measurement of the carrier phase, for each received satellite signal. Measuring the instantaneous phase of the received carrier allows a pseudo-range to be calculated, called carrier pseudo-range, between the receiver and the satellite, in the same way as measuring the instantaneous phase of the pseudo-random code. This carrier pseudo-range undergoes the same variations as the code pseudo-range when the distance between the receiver and the satellite or the time bias due to the receiver clock varies. This phase-measured pseudo-range is initially ambiguous since the phase is known modulo 2π, but it is much less noisy than code pseudo-range measurements.

A known solution to improve pseudo-range measurements consists of smoothing the noisy pseudo-range measurements carried out on the code by the less noisy phase measurements, satellite axis by satellite axis.

A technique recommended by civil aviation standards to carry out such smoothing is to use a first-order filter. However, such a filter must be reset, with a penalizing convergence time, each time a temporary carrier loop dropout occurs, for example, following an ionospheric scintillation episode. Given typical convergence times of about one hundred seconds and an average duration between two dropouts of ten seconds, satellite measurements are always unavailable in the presence of strong ionospheric scintillations, which is particularly problematic in the case of an aeronautical receiver.

Another technique, described in EP 3 223 038 A1, is to carry out this smoothing with a Kalman filter recalibrated on the code pseudo-range and pseudo-range carrier measurements of the two frequencies. The advantage of the Kalman filter relative to the first-order filter is that it allows to better manage the loss of one of the two frequencies that occurs, for example, following a temporary carrier loop dropout due to ionospheric scintillation as it maintains the continuity of smoothing and ionospheric bias estimation.

The invention relates to a satellite positioning calculated using pseudo-ranges smoothed by Kalman smoothing.

There are many reasons why the two measurements are not available simultaneously on some satellites:
the acquisition and demodulation times of the transmitted navigation messages are not the same;
some older satellites do not emit on both frequency bands;
one of the two bands may be jammed.

In case of interference on one of the two bands, the satellites do not all drop out at the same time due to different emitted powers and due to the antenna gain which depends on the satellite direction.

The effect of the propagation time difference Δ_{TPG}, between the two frequencies is not the same according to whether the measurement is dual-frequency or single-frequency, on one or the other of the two frequencies.

However, when resolving the position from code measurements, if a bias on the code measurements common to all measurements has no effect on the position since it is found in the resolved time error, this is no longer true if the bias is not the same on all measurements.

That is why mixing measurements is avoided, and one must choose between using only dual-frequency measurements or using only single-frequency measurements on the same frequency.

The disadvantage is that this leads to forgoing certain satellite axes, to the detriment of the geometry of the axes in view used and therefore of the precision and integrity (increased RAIM protection radius).

A known solution to mix dual-frequency and single-frequency measurements consists of adding a fifth state in the position resolution, representative of the propagation time difference Δ_{TPG}, in addition to the 3 spatial coordinates and the receiver clock time bias, knowing that in the case of code carrier smoothing, for example with a first-order filter, the coefficient of the linear relationship linking the value of Δ_{TPG}, to the bias induced on the code measurement according to whether it is dual-frequency or single-frequency, is known.

But in the case of code carrier smoothing performed with a Kalman filter, there is already a mix of dual-frequency and single-frequency measurements due to possible dropouts in the past on one of the two frequencies, and the value of this coefficient, which may evolve over time, is not known.

### SUMMARY

The aim of the invention is then to improve the positioning determined by dual-frequency satellites in the case of pseudo-range measurements smoothed by a Kalman filter.

To this end, the invention has as its object a method for satellite geopositioning implemented by a geopositioning terminal from N satellites, with N≥4, each emitting electromagnetic geopositioning signals, called dual-frequency, on two different frequencies Fa, Fb, each of said signals being formed of a carrier frequency modulated by a spreading code, said terminal comprising at least one reception module configured to receive electromagnetic signals coming from each satellite on two different frequencies and at least one calculation module configured to process said signals, said method comprising, for each geopositioning satellite, for each considered instant of a succession of considered instants of determining the position of the geopositioning terminal:
a step of calculating, in nominal mode, of four pseudo-ranges, a pseudo-range being calculated from each element from among the two codes and the two carriers of the received dual-frequency geopositioning signals;
a step of correcting ionospheric delays on each calculated pseudo-range by applying an ionospheric error propagation model;
a step of code carrier smoothing using a Kalman filter the measurement vector of which comprises the four corrected pseudo-ranges and the state vector of which comprises a single smoothed pseudo-range, said carrier smoothing step using a Kalman filter having the function of correcting measurement noise and residual ionospheric error and comprising two steps successively implemented on the state vector, to provide in the propagated and recalibrated state vector a single smoothed pseudo-range measurement:
one of the two steps being a step of propagating, as a function of a propagation matrix; and
the other of the two steps being a step of recalibration, as a function of said measurement vector and a recalibration gain matrix;
the position of the geopositioning terminal being estimated using the smoothed pseudo-ranges calculated for each satellite;
   said propagation matrix being also used to propagate another vector, called a fictitious state vector, of the same size as the state vector, said propagated fictitious state vector being also recalibrated as a function of said recalibration gain matrix and a fictitious measurement vector of the same size as said measurement vector and including components of predefined constant values, common to said determination instants;
   a coefficient, called a proportionality constant, indicating the ratio between a propagation difference between the two frequencies in the terminal and the bias induced by said difference on said smoothed pseudo-range is determined as a function of the component of the fictitious state vector of the same rank as the rank of the smoothed pseudo-range in the state vector;
   the position of the geopositioning terminal is estimated as a function of said N smoothed pseudo-ranges for the N satellites and the N proportionality constants determined for the N satellites.

According to other advantageous aspects of the invention, the method for geopositioning comprises one or more of the following features, taken individually or in any technically possible combination:
if the propagation time reference corresponds to the frequency Fa, the proportionality constant is determined as the result of the ratio between, on the one hand, the component of the fictitious state vector of the same rank as the rank of the smoothed pseudo-range in the state vector and, on the other hand, the component of the fictitious measurement vector of the same rank as the rank, in the measurement vector, of the code pseudo-range for frequency Fb;
the component of the fictitious measurement vector of the same rank as the rank, in the measurement vector, of the code pseudo-range for frequency Fa, is set to 0;
the two components of the fictitious measurement vector of the same rank as those in the measurement vector, of the code and carrier pseudo-ranges for the frequency Fb are set to 1, the other two being set to 0;
if the pseudo-ranges of one of the two frequencies of the measurement vector are not available during a time interval, a corresponding reduction in the dimension of the observation model implemented by the Kalman filter is applied during said interval, said reduction comprising a reduction in the number of components of each of the vectors from among said measurement vector and said fictitious measurement vector;
the position of the geopositioning terminal is estimated by solving the system

$${Z}_{sat} = {H}_{pos sat} \cdot {X}_{pos}$$

where each component of the vector Xₚₒₛ is a function of a respective unknown from among the position unknowns to be determined x, y, z, t, ATPG
the i^{th} component of the vector Zₛₐₜ i=1 to N is a function of the smoothed pseudo-range calculated for the i^{th} satellite
where if (cos θₓᵢ, cos θ_{yi}, cos θ_{zi}) are the direction cosines in the direction of the i^{th} satellite and ρᵢ is the proportionality constant calculated for the i^{th} satellite for the considered instant, the i^{th} line of H_{pos sat} includes the components, cos θₓᵢ, cos θ_{yi}, cos θ_{zi}, a constant and ρᵢ.

The invention also relates to a non-transitory computer-readable medium including a computer program including software instructions which, when executed by a computer, implement a method for geopositioning such as defined above.

The invention also relates to a geopositioning terminal comprising at least one reception module configured to receive electromagnetic geopositioning signals, called dual-frequency, emitted by at least four satellites on two different frequencies and at least one calculation module configured to process said geopositioning signals and implement the method for geopositioning according to the invention.

### BRIEF DESCRIPTION OF THE DRAWINGS

The invention will become clearer upon reading the following description, given solely as a non-limiting example, and made with reference to the drawings in which:

FIG. 1 represents an example of a block diagram of a method for satellite geopositioning according to the invention;

FIG. 2 represents an example of a flowchart of the operation of a Kalman filter implemented in a receiver according to the invention;

FIG. 3 represents an example of a flowchart of position resolution implemented in a receiver according to the invention.

### DETAILED DESCRIPTION

Subsequently, it will be assumed that each geopositioning satellite emits electromagnetic geopositioning signals on two different carrier frequencies. Dual-frequency signals will be referred to and these two frequencies denoted, Fa and Fb.

It will also be assumed that there is never a dropout of both carriers at the same time (or for during a very short period), and that the geopositioning receiver receives at least one of the two geopositioning signals.

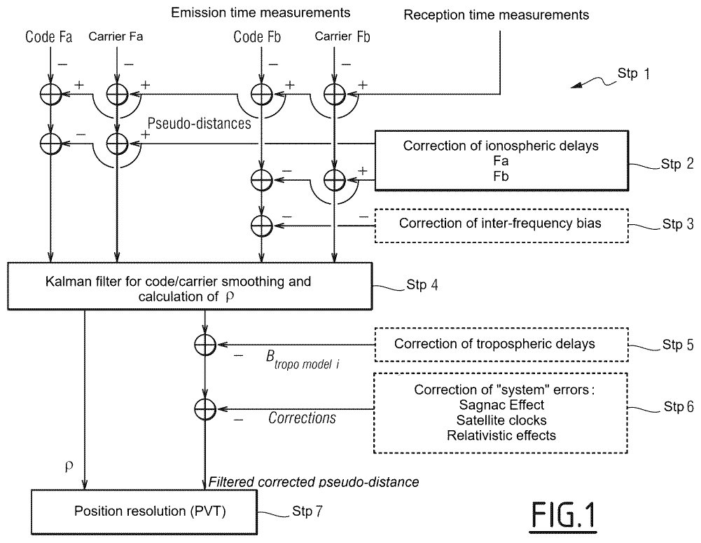

FIG. 1 represents an example of a block diagram, for each satellite axis, of a method for satellite geopositioning according to one embodiment of the invention.

This method is implemented by a geopositioning receiver from electromagnetic geopositioning signals emitted by at least four geopositioning satellites. As stated previously, each of these signals is formed of a carrier frequency modulated by a spreading code.

The method comprises 7 steps Stp1 to Stp7. This set of steps is iterated for each new instant tₙ considered. Steps Stp1 to Stp6 are carried out, for example in parallel, by considering each satellite independently.

The step Stp7 uses the results determined for the considered instant by the satellites.

The method comprises, for each visible satellite considered, a first step Stp1 of measuring pseudo-ranges. For this, the geopositioning receiver comprises at least one reception module configured to receive these electromagnetic signals coming from each satellite on the two frequencies Fa and Fb.

As is known, this reception module may comprise at least one antenna, an analog circuit carrying out amplifications, filtering, and frequency changes, an analog-to-digital converter, and at least N digital processing channels. Each channel being assigned to a satellite, the integer N will be chosen greater than the number of satellites from which geopositioning signals are to be received.

Each digital channel receives a digitized signal containing all the satellite signals that it submits to a dual control loop allowing, on the one hand, to synchronize in phase a locally generated carrier with the carrier from the considered satellite and, on the other hand, to synchronize a locally generated pseudo-random code with an identical code present in the satellite signal and specific to that satellite.

The two control loops may each comprise two numerically controlled oscillators, the content of which represents, for the first oscillator, the instantaneous phase of the local pseudo-random code (aligned with the code present in the signal), which constitutes the measurement of the instantaneous phase of the received code and for the second oscillator, the instantaneous phase of the local carrier (aligned with the phase of the carrier present in the signal received from the satellite, except for the phase shift introduced by the receiver circuits), which constitutes the measurement of the instantaneous phase of the received carrier.

The measurement of the instantaneous phase of the code in each channel is used to calculate a first numerical data called code pseudo-range PR_{code} representing a first measurement of the pseudo-range between the receiver and the considered satellite. This measurement is unambiguous but quite noisy.

The measurement of the instantaneous phase of the carrier in the considered channel is used to calculate a second numerical data, called carrier pseudo-range PR_{carrier}, representing a second measurement of the pseudo-range between the receiver and the considered satellite. This measurement is less noisy but ambiguous.

The signals being dual-frequency, in nominal mode, two code pseudo-ranges and two carrier pseudo-ranges are thus calculated for each visible satellite of the receiver. Therefore, in each digital channel, there are four independent measurements (PR_{code a}, PR_{code b}, PR_{carrier a}, PR_{carrier b}) of the same pseudo-range separating the receiver from each visible satellite of the latter. For each satellite, the two types of pseudo-range measurements (PR_{code} and PR_{carrier}) are obtained in the form of signal propagation durations between the considered satellite and the receiver along the axis (satellite axis) joining the considered satellite and the receiver.

At the considered instant tₙ, the pseudo-ranges PR_{code Fa}(n), PR_{code Fb}(n) and PR_{carrier Fa}(n), PR_{carrier Fb}(n), measured respectively on the code and the carrier at frequency Fa and frequency Fb, are given by the formulas:

$${PR}_{code a} ( n ) = ( {T}_{rec eption} ( n ) - {T}_{sat a} ( n ) )$$

$${PR}_{code b} ( n ) = ( {T}_{rec eption} ( n ) - {T}_{sat b} ( n ) )$$

$${PR}_{carrier a} ( n ) = ( {T}_{reception} ( n ) - {φ}_{carrier a} ( n ) / Fa )$$

$${PR}_{carrier b} ( n ) = ( {T}_{reception} ( n ) - {φ}_{carrier b} ( n ) / Fb )$$

in which:
   T_{reception}(n) represents the reception date of the considered signals at the instant tₙ, given by the receiver clock,
   T_{sat a}(n) represents the emission date, by the satellite, of such a signal received by the receiver, given by the local code phase,
   φ_{carrier a}(n) represents the phase of the local carrier, brought back to carrier frequency (cycles),

For each visible satellite of the geopositioning receiver, the method for geopositioning comprises a step Stp2 of correcting ionospheric delays on each calculated pseudo-range by applying an ionospheric error propagation model. For this, the receiver also comprises at least one calculation module configured to process the received signals.

The ionospheric error propagation model can be a Klobuchar model, a Nequick model, or any other equivalent model known to those skilled in the art.

The ionospheric error propagation model provides an estimate of the ionospheric delay on the code pseudo-range measurement of a frequency, for example, the frequency Fa, as a function of the position on Earth and the time of day. This ionospheric error represents the group delay induced on the signal propagation when crossing the ionosphere. This delay is proportional to the total electronic content (TEC) of the atmospheric column crossed by the signal and inversely proportional to the square of the carrier frequency. The delay is found on the code measurement. The effect on the carrier is a phase advance of the same absolute value.

If the ionospheric error on the frequency Fa is considered:
on the carrier Fa measurement, there is a phase advance of −Bᵢₒₙₒ,
on the carrier Fb measurement, there is a phase advance of −γ·Bᵢₒₙₒ,
on the code Fa measurement, there is a delay of Bᵢₒₙₒ=α. TEC/Fa² and
on the code Fb measurement, there is a delay of γ·Bᵢₒₙₒ=α. TEC/Fb²
with γ=Fa²/Fb².

Therefore, to correct the code and carrier phase measurements, the following corrections are applied:
On PR_{code a}(n): −B_{iono model}
On PR_{carrier a}(n): +B_{iono model}
On PR_{code b}(n): −γ B_{iono model}
On PR_{carrier b}(n): +γ B_{iono model}

Of course, a similar reasoning can be made by considering a model providing an estimate of the ionospheric error on the frequency Fb.

In order to process the signals emitted by the geopositioning satellites at the two frequencies Fa and Fb, the reception module comprises two distinct analog paths. When this reception module receives two signals of different frequencies, the propagation times in each of the analog paths of the module can be different. This has the effect of introducing group delay differences between the two frequencies Fa and Fb, called RF biases and noted hereafter ATPG.

When the measurements are homogeneous, in other words, all single-frequency on the same frequency or all dual-frequency, the RF biases, common to all satellites, have no effect on the resolved position. However, when mixing single-frequency measurements on different frequencies or single-frequency and dual-frequency, distortions are introduced between the satellite measurements, therefore an error on the resolved position. This scenario can occur, for example, when one of the two dual-frequency signals is not received by the geopositioning receiver, for example, due to ionospheric scintillation problems.

In order to avoid this, in one embodiment, for each visible satellite, the method comprises a step Stp3 of compensating for an inter-frequency bias between the dual-frequency signals. The step Stp3 is therefore optional.

During this step, the calculation module identifies the RF bias gap between the two frequencies on the dual-frequency signal measurements and corrects this gap on all satellites by compensating for the gap between the two frequencies only on the code measurements and only on one of the two frequencies. The identification of the RF bias and its correction can be implemented using techniques known to those skilled in the art, notably the one developed in patent application FR 2 943 868. The RF bias gap can be estimated by averaging all available dual-frequency signal measurements from the beginning (average overtime and satellites) and considering that the RF biases are constant over time.

The dual-frequency code measurements of each satellite are then smoothed by the dual-frequency carrier measurements during a step Stp4 of smoothing the compensated pseudo-ranges using a Kalman filter. During this step, the Kalman filter simultaneously carries out code carrier smoothing and residual ionospheric error correction.

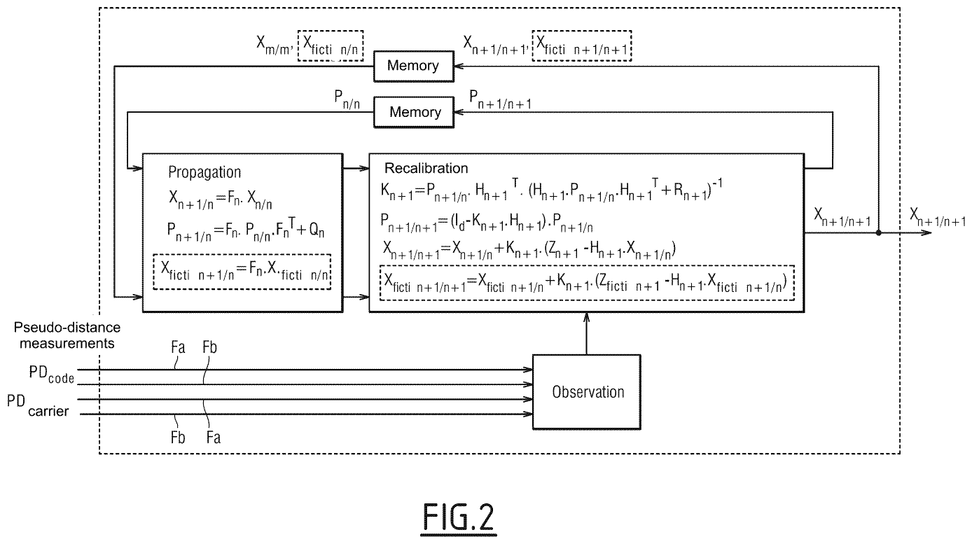

With reference to FIG. 2, the operating principle of Kalman filtering is recalled.

Kalman filtering uses a state model, established on the basis of the known (proven or assumed) behavior of the unknown physical quantities that are to be determined and the available measurements.

This state model consists of:
a state vector Xₙ representing the modeled physical quantities at the instant tₙ, including a number of components Nₛₜₐₜₑ.
a propagation model, of the form: Xₙ₊₁=Fₙ. Xₙ+Vₙ in which: Xₙ₊₁ is the state vector at instant tₙ₊₁
Fₙ is the propagation matrix over the interval [tₙ, tₙ₊₁], of dimension Nₛₜₐₜₑ×Nₛₜₐₜₑ (in which the operator “x” represents the multiplication sign)
Vₙ is the propagation noise vector over the interval [tn, tn+1], white, Gaussian, of zero mean, of covariance matrix Qₙ=E[Vₙ^{T}·Vₙ] (where Vₙ^{T} is the transposed vector of Vₙ) and of dimension Nₛₜₐₜₑ,
   an observation model, of the form: Zₙ=Hₙ·Xₙ+Wₙ in which:
Zₙ is the observation vector at instant tₙ, of dimension N_{obs}
Hₙ is the observation matrix at instant tₙ, of dimension N_{obs}×Nₛₜₐₜₑ
Wₙ is the measurement noise vector at instant tₙ, white, Gaussian, of zero mean, of covariance matrix Rₙ=E[Wₙ^{T}·Wₙ] (where Wₙ^{T} is the transposed vector of Wₙ) and of the dimension N_{obs}.

In this state model, the state vector Xₙ is of a priori an unknown value. It is not directly accessible by measurement, unlike the observation vector Zₙ, but only by means of the observation model.

The Kalman filter carries out the estimation of the state vector by a propagation calculation, from the propagation model, and by a recalibration calculation, from the observations and the observation model.

For this, the filter uses two variables:
the estimated state vector, noted X_{n/n} after recalibration at the instant tₙ, noted X_{n+1/n} after propagation between the successive instants tₙ and tₙ₊₁, and noted X_{n+1/n+1} after recalibration at the instant tn+1, of the dimension Nₛₜₐₜₑ;
the covariance matrix of the estimated state, noted P_{n/n} after recalibration at the instant tₙ, noted P_{n+1/n} after propagation between the instants tₙ and tₙ₊₁, and noted P_{n+1/n+1} after recalibration at the instant tₙ₊₁, of the dimension Nₛₜₐₜₑ×Nₛₜₐₜₑ.

To carry out the propagation calculation, the filter uses the formulas:
for the estimated state vector: X_{n+1/n}=Fₙ. X_{n/n}
the propagation matrix Fₙ serving to establish a linear relationship between the state vector before propagation and after propagation;
for the covariance matrix: P_{n+1/n}=Fₙ·P_{n/n}·Fₙ^{T}+Qₙ
(in which Fₙ^{T} represents the transposed matrix of Fₙ).

In this formula, the coefficients of the covariance matrix Pₙ represent the variance of each component of the estimated state vector (diagonal terms) and the covariance of the different pairs of components of this vector (non-diagonal terms). This matrix Pₙ represents the degree of confidence attributed to the estimated state vector.

The covariance matrix Qₙ of the propagation noise allows to quantify the random part and the approximations made in the propagation model for each component of the state vector X_{n/n}.

To carry out the recalibration calculation, the filter uses the following formulas:
for the recalibration gain: Kₙ₊₁=P_{n+1/n}·Hₙ₊₁^{T}·(Hₙ₊₁·P_{n+1/n}·Hₙ₊₁^{T}+Rₙ₊₁)⁻¹
(where Hₙ₊₁^{T} is the transposed matrix of Hₙ₊₁);
the observation matrix Hₙ serves to establish a linear relationship between the state vector and the measurements;
the covariance matrix Rₙ characterizes the intrinsic noise of the measurements. Rn is a square matrix of the dimension N_{obs}×N_{obs},
for the estimated state vector: X_{n+1/n+1}=X_{n+1/n}+Kₙ₊₁·(Zₙ₊₁−Hₙ₊₁·X_{n+1/n})
for the covariance matrix: P_{n+1/n+1}=(Id_{Nstate}−Kₙ₊₁·Hₙ₊₁)·P_{n+1/n}
(in which Id Nₛₜₐₜₑ represents the identity matrix of the dimension Nₛₜₐₜₑ·Nₛₜₐₜₑ).

Initially (n=0), the state vector X₀ is initialized to zero, and the matrix P₀ is initialized with the variances and covariances representative of the uncertainty on the physical quantities modeled in the state vector.

The propagation calculation involves the matrices Fₙ and Qₙ to determine the propagated estimated state vector X_{n+1/n} from the recalibrated estimated state vector X_{n/n} and the propagated covariance matrix P_{n+1/n} from the recalibrated covariance matrix P_{n/n}.

The recalibration calculation involves the observations Zₙ₊₁ from the measurements and the matrices Hₙ₊₁ and Rₙ₊₁, to determine the recalibrated estimated state vector X_{n+1/n+1} from the propagated estimated state vector X_{n+1/n} and the recalibrated covariance matrix P_{n+1/n+1} from the propagated covariance matrix P_{n/n}.

The index n is then incremented by 1 (that is, n replaced by n+1), and the propagation, then the recalibration, are repeated. Thus, an alternation of propagation, recalibration, and index incrementation is chained. Here, a cycle was considered to start with propagation and end with recalibration, the smoothed pseudo-range therefore being the one obtained after propagation and then recalibration. In another embodiment, a cycle is considered to start with propagation and end with recalibration.

In FIG. 2, a memory collecting X_{n+1/n+1} and providing X_{n/n} is represented to indicate that the state vector value introduced into the propagation model for the calculation of X_{n+1/n} dated at instant tₙ₊₁ is the state vector value X_{n/n} which was calculated at the previous instant tₙ. Similarly, a memory is represented for the covariance matrix P_{n/n} and for the estimated position G_{n/n}.

In the code carrier smoothing filter according to one embodiment of the invention, the state vector X and the evolution model represented by the matrices Fₙ=F and Fₙ=Q, are as follows:

$$X = [ \begin{matrix}PR \\ {B}_{iono} \\ {δ}_{a} \\ {δ}_{b} \\ {Δ}_{TPG}\end{matrix} ]$$

$$F = [ \begin{matrix}1 & 0 & 0 & 0 & 0 \\ 0 & {λ}_{iono} & 0 & 0 & 0 \\ 0 & 0 & 1 & 0 & 0 \\ 0 & 0 & 0 & 1 & 0 \\ 0 & 0 & 0 & 0 & 1\end{matrix} ]$$

$$Q = [ \begin{matrix}{q}_{PD} & 0 & 0 & 0 & 0 \\ 0 & {q}_{iono} & 0 & 0 & 0 \\ 0 & 0 & {q}_{a} & 0 & 0 \\ 0 & 0 & 0 & {q}_{b} & 0 \\ 0 & 0 & 0 & 0 & 0\end{matrix} ]$$

in which:
   PR represents the pseudo-range without receiver measurement noise (thermal noise, interference, multipath) and without ionospheric error;
PR=satellite receiver distance+receiver clock bias x c+tropospheric error+satellite bias
   Bᵢₒₙₒ represents the ionospheric error on a frequency (for example, on the frequency Fa) after correction by the model (residual);
   δₐ represents the floating ambiguity of the carrier phase measurement on the frequency Fa;
   δ_{b} represents the floating ambiguity of the carrier phase measurement on the frequency Fb;
   Δ_{TPG} represents the inter-frequency bias of the analog path of the frequency Fb compared to the analog path of the frequency Fa (in one embodiment where step Stp3 has been carried out, this bias Δ_{TPG} represents the residual RF bias after this correction);
   λᵢₒₙₒ represents the attenuation factor of the Markov model of the ionospheric error;

$${λ}_{iono} = 1 - Δ T / τ$$

ΔT representing the filter recalibration period and t the time constant of the Markov model (1st order) of the ionospheric error after correction by the model. ΔT=1 s and τ=2000 s will be used;
q_{PR} represents the state noise on the true pseudo-range. A very large value will be chosen for this component because no reliable evolution model is available. For example, q_{PR}=(1000 m)² will be used;
qᵢₒₙₒ represents the state noise of the Markov model (1st order) of the ionospheric error after correction by the model;

$${q}_{iono} = {σ}_{iono}^{2} \cdot 2 \cdot Δ T / τ$$

σᵢₒₙₒ representing the standard deviation of the ionospheric error after correction by the model; for example, σᵢₒₙₒ=(20 m)² will be used;
   qₐ represents the state noise of the carrier phase measurement ambiguity on the frequency Fa; for example, qₐ=(10⁻² m)² will be used;
   q_{b} represents the state noise of the carrier phase measurement ambiguity on the frequency Fb; for example, q_{b}=(10⁻² m)² will be used.

The matrices representative of the measurements and the observation model are written here:

$${Z}_{n} = [ \begin{matrix}{PD}_{code a} ( n ) \\ {PR}_{carrier a} ( n ) \\ {PR}_{code b} ( n ) \\ {PR}_{carrier b} ( n )\end{matrix} ]$$

$$R = [ \begin{matrix}{σ}_{code a}^{2} & 0 & 0 & 0 \\ 0 & {σ}_{carrier a}^{2} & 0 & 0 \\ 0 & 0 & {σ}_{code b}^{2} & 0 \\ 0 & 0 & 0 & {σ}_{carrier b}^{2}\end{matrix} ]$$

$$H = [ \begin{matrix}1 & + 1 & 0 & 0 & 0 \\ 1 & - 1 & 1 & 0 & 0 \\ 1 & + γ & 0 & 0 & 1 \\ 1 & - γ & 0 & 1 & 1\end{matrix} ]$$

in which:
   PR_{code a}(n) represents the pseudo-range measured on the code of the frequency Fa, for the considered instant tₙ=n·ΔT;
   PR_{carrier a}(n) represents the pseudo-range measured on the code of the frequency Fa, for the considered instant tₙ=n·ΔT;
   PR_{code b}(n) represents the pseudo-range measured on the code of the frequency Fb, for the considered instant tₙ=n·ΔT;
   PR_{carrier b}(n) represents the pseudo-range measured on the code of the frequency Fb, for the considered instant tₙ=n·ΔT;
   σ_{code a} and σ_{code b} represent respectively the standard deviation of the code phase measurement error specific to the receiver for the frequencies Fa and Fb;
   σ_{carrier a} and σ_{carrier b} represent respectively the standard deviation of the carrier phase measurement error specific to the receiver for the frequencies Fa and Fb.

Of course, the order of the components in the observation vectors and the state vector X was chosen arbitrarily. It can be chosen differently, the components of the matrices used in the recalibration and propagation calculations being simply moved as a function of the order of the components in the observation vectors and in the state vector X.

Thus, for a considered satellite, for each considered processing instant tₙ, at the end of the step Stp4, a smoothed pseudo-range is delivered, resulting from the filtering by the Kalman filter of the four pseudo-ranges which were provided to it as input, as well as a determined coefficient value p.

According to the invention, during each processing instant, the calculation module also calculates, in parallel with the Kalman filter, a coefficient ρ equal to the proportionality constant between the propagation difference Δ_{TPG} and the bias induced by ATPG on the smoothed code measurement at the Kalman filter output.

Notably, this calculation uses the recalibration gains of the Kalman filter used to determine the state vector X and applies them to a “fictitious” estimated state vector, named X_{fictive}, recalibrated on 4 fictitious pseudo-range measurements, indicated in a fictitious observation vector Z_{fictive} which in one embodiment takes the following constant values (these values remain constant for all successive processing instants considered t₀, t₁, t₂, . . . , tₙ, tₙ₊₁ . . . ):
for all n,

$${Z}_{fictive n} = {X}_{fictive} = \begin{matrix}[ \begin{matrix}0 \\ 0 \\ 1 \\ 1\end{matrix} ] & \begin{matrix}componant corresponding to {PR}_{code a} in {Z}_{n} \\ componant corresponding to {PR}_{carrier a} in {Z}_{n} \\ componant corresponding to {PR}_{code b} in {Z}_{n} \\ componant corresponding to {PR}_{carier b} in {Z}_{n}\end{matrix}\end{matrix}$$

The recalibration and propagation operations of the fictitious state vector are carried out by the calculation module using the fictitious observation vector and the propagation, recalibration gain, and observation matrices determined during the determination of the recalibration and propagation of the vector X, at the current considered processing instant tₙ.

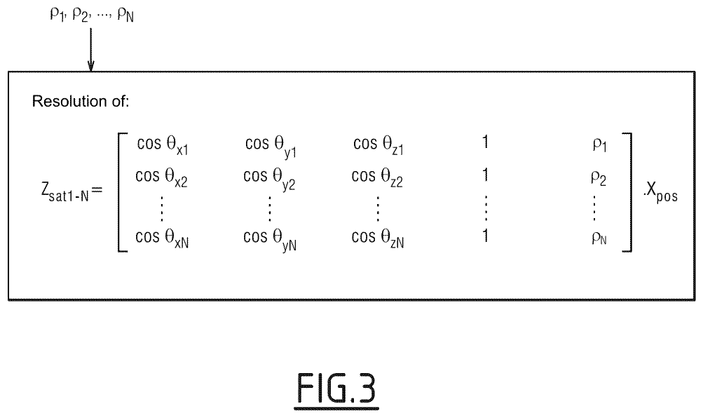

Thus, in the considered example, referring to [FIG. 3] FIG. 3:
the recalibration step of X_{fictive} (the indices n/n, n+1/n, n+1/n+1 of X_{fictive}
have the same meanings regarding the propagated, recalibrated state as those explained above for the state vector X):

$${X}_{fictive n / n} = {X}_{fictive n / n - 1} - {K}_{n} \cdot ( {Z}_{fictive n} - H \cdot {X}_{fictive n / n - 1} )$$

the propagation step:

$${X}_{fictive n + 1 / n} = F \cdot {X}_{fictive n / n}$$

The coefficient ρ is given on the first component of the fictitious state vector:

$${X}_{fictive n / n} = [ \begin{matrix}ρ \\ {x}_{2} \\ {x}_{3} \\ {x}_{4} \\ {x}_{5}\end{matrix} ]$$

The value of this coefficient as determined at the current processing instant is equal to the bias induced on the smoothed pseudo-range at the Kalman filter output for a known constant inter-frequency bias Δ_{TPG} equal to 1 (that is, 1 meter); it is therefore equal to the proportionality constant between Δ_{TPG} and the bias induced by this propagation time difference on the smoothed measurement at the Kalman filter output.

### Initialization

During initialization (that is, for the processing instant to), the state vector X, the fictitious state vector X_{fictive}, and the covariance matrix P have the value:

$${X}_{0 / 0} = [ \begin{matrix}0 \\ 0 \\ 0 \\ 0 \\ 0\end{matrix} ] \qquad {P}_{0 / 0} = [ \begin{matrix}{1000}^{2} & 0 & 0 & 0 & 0 \\ 0 & {σ}_{iono}^{2} & 0 & 0 & 0 \\ 0 & 0 & {1000}^{2} & 0 & 0 \\ 0 & 0 & 0 & {1000}^{2} & 0 \\ 0 & 0 & 0 & 0 & {σ}_{R F}^{2}\end{matrix} ]$$

$${X}_{fictive 0 / 0} = [ \begin{matrix}ρ \\ {x}_{2} \\ {x}_{3} \\ {x}_{4} \\ {x}_{5}\end{matrix} ] = [ \begin{matrix}0 \\ 0 \\ 0 \\ 0 \\ 0\end{matrix} ]$$

σᵢₒₙₒ represents the standard deviation of the ionospheric error on the line of sight of the considered satellite. Its value is given by atmospheric models, as a function of the satellite axis inclination, the latitude of the receiver, and the time of day. Here, for example, σᵢₒₙₒ=30 m is used;
σ_{RF} represents the standard deviation of the error on the inter-frequency bias on the line of sight of the considered satellite; here, for example, σ_{RF}=3 m is used.

In the described embodiment, the fictitious observation vector of values

$${Z}_{fictive n} = [ \begin{matrix}0 \\ 0 \\ 1 \\ 1\end{matrix} ]$$

was chosen for simplicity. Other constant values could be chosen.

For example, a constant value, named λ, could be chosen instead of 1 in the last two components, in which case, the first component of the fictitious vector X_{fictive} would then be equal to the product λ.p. In one embodiment, it is possible to choose any values (constant regardless of n) on the components corresponding to the carrier pseudo-range measurements PR_{carrier a} and PR_{carrier b} of the fictitious observation vector, Z_{fictive n}, (by way of the floating ambiguity components of the state vector, δₐ and δ_{b}). However, in the present case, it is necessary to set the first component PR code a of Z fictitious, Z_{fictive n}, to zero because, via the observation matrix H, it was indicated in the considered example that Δ_{TPG} was observable only on the measurements of the frequency Fb (PR_{code b} et PR_{carrier b}): indeed, the delay of the frequency Fb relative to the frequency Fa, which plays the reference here, was of interest.

When a satellite drops out on a frequency, in other words, one of the two dual-frequency signals emitted by a geopositioning satellite is not received by the receiver or is received with too low an amplitude, the observation model is modified. The two lines corresponding to these measurements in the matrices Z, R, and H are removed.

If, for example, on a satellite axis, the measurements on the frequency Fb become unavailable and only the measurements on the frequency Fa are available, the matrices representative of the observation model become:

$${Z}_{n} = [ \begin{matrix}P {D}_{code a} ( n ) \\ P {D}_{carrier a} ( n )\end{matrix} ] \qquad R = [ \begin{matrix}{σ}_{code a}^{2} & 0 \\ 0 & {σ}_{carrier a}^{2}\end{matrix} ] \qquad H = [ \begin{matrix}1 & + 1 & 0 & 0 & 0 \\ 1 & - 1 & 1 & 0 & 0\end{matrix} ]$$

$${Z}_{fictif n} = [ \begin{matrix}0 \\ 0\end{matrix} ] \qquad \begin{matrix}P {D}_{code a} \\ P {D}_{carrier a}\end{matrix}$$

Similarly, when the measurements on the frequency Fa become unavailable, the observation model is written:

$${Z}_{n} = [ \begin{matrix}P {D}_{code b} ( n ) \\ P {D}_{carrier b} ( n )\end{matrix} ] \qquad R = [ \begin{matrix}{σ}_{code b}^{2} & 0 \\ 0 & {σ}_{carrier b}^{2}\end{matrix} ] \qquad H = [ \begin{matrix}1 & + γ & 0 & 0 & 1 \\ 1 & - γ & 1 & 0 & 1\end{matrix} ]$$

$${Z}_{fictif n} = [ \begin{matrix}1 \\ 1\end{matrix} ] \qquad \begin{matrix}P {D}_{code b} \\ P {D}_{carrier b}\end{matrix}$$

When the measurements become available again, the two lines associated with these measurements in the matrices Z, R, and H are restored. Furthermore, for the newly available frequency, the estimation of the phase measurement ambiguity of the state vector X is reset to 0 before recalibration on the 4 measurements. The diagonal coefficient (variance) associated with the carrier phase ambiguity in the matrix P is reset to a value much larger than the commonly used orders of magnitude. This value is artificially increased to indicate to the filter that the ambiguity estimation is no longer good and that it must be reset. This variance can be set to a value of 1000².

When the measurements on the frequency Fa become available again, the state vector X and the covariance matrix P are written:

$${X}_{n + 1 / n} = [ \begin{matrix}P {R}_{n + 1 / n} \\ {B}_{{iono}_{n + 1 / n}} \\ 0 \\ {δ}_{b n + 1 / n} \\ {Δ}_{TPG}\end{matrix} ]$$

$${P}_{n + 1 / n} = {P}_{n + 1 / n} + [ \begin{matrix}0 & 0 & 0 & 0 & 0 \\ 0 & 0 & 0 & 0 & 0 \\ 0 & 0 & {1000}^{2} & 0 & 0 \\ 0 & 0 & 0 & 0 & 0 \\ 0 & 0 & 0 & 0 & 0\end{matrix} ]$$

and the 4^{th} component of the propagated fictitious state vector X_{fictive n+1/n} is forced to zero.

Similarly, when the measurements on the frequency Fb become available again, we

$${X}_{n + 1 / n} = [ \begin{matrix}P {R}_{n + 1 / n} \\ {B}_{{iono}_{n + 1 / n}} \\ {δ}_{a n + 1 / n} \\ 0 \\ {Δ}_{TPG}\end{matrix} ]$$

$${P}_{n + 1 / n} = {P}_{n + 1 / n} + [ \begin{matrix}0 & 0 & 0 & 0 & 0 \\ 0 & 0 & 0 & 0 & 0 \\ 0 & 0 & 0 & 0 & 0 \\ 0 & 0 & 0 & {1000}^{2} & 0 \\ 0 & 0 & 0 & 0 & 0\end{matrix} ]$$

and the 4th component of the propagated fictitious state vector X_{fictive n+1/n} is forced to zero.

When a discontinuity is observed on the carrier phase measurement of one of the two frequencies, the state vector and the covariance matrix, are reset in the same way before recalibration on the new carrier phase measurement.

The Kalman Filter allows both the code carrier and the “iono-free” combination smoothing to be caried out: for the considered positioning processing instant tn: at the filter input, four pseudo-ranges are provided from which the filter provides the useful data, which is the pseudo-range PR, filtered and corrected for the ionospheric error, corresponding to the first coordinate of the estimated state vector after recalibration X_{n+1/n+1}.

Since the model corrections are applied upstream of the Kalman filter, it only has to identify the residual ionospheric error. The error calculated using the model follows the same Markov model as the ionospheric error, therefore a fortiori the difference too, with a smaller amplitude. The correction itself being proportional to the inverse of the square of the frequency, the residual error is also, therefore the observation model linking the filter state to the dual-frequency measurements remains unchanged.

The Klobuchar or Nequick models are ionospheric error prediction models that are normally used to correct single-frequency measurements. In the case of dual-frequency measurements, the fact of making the “iono-free” combination of signals on two different frequencies, normally allows the ionospheric error to be eliminated. In the method according to the invention, this model is useful when one of the two frequencies is no longer available, and the measurement becomes single-frequency.

According to an alternative embodiment, the state vector X_{n/n} and the fictitious state vector X_{fictive n/n} each comprise four states. In this case, the evolution model matrices F and Q are also four-dimensional. The state vector X_{n/n}, the fictitious state vector X_{fictive n/n} and the evolution model become:

$$F = [ \begin{matrix}1 & 0 & 0 & 0 \\ 0 & {λ}_{iono} & 0 & 0 \\ 0 & 0 & 1 & 0 \\ 0 & 0 & 0 & 1\end{matrix} ] \qquad Q = [ \begin{matrix}{q}_{PD} & 0 & 0 & 0 \\ 0 & {q}_{iono} & 0 & 0 \\ 0 & 0 & {q}_{a} & 0 \\ 0 & 0 & 0 & {q}_{b}\end{matrix} ]$$

$${X}_{n / n} = [ \begin{matrix}P R \\ {B}_{iono} \\ {δ}_{a} \\ {δ}_{b}\end{matrix} ] \qquad {X}_{fictive n / n} = [ \begin{matrix}ρ \\ {x}_{2} \\ {x}_{3} \\ {x}_{4}\end{matrix} ]$$

In the absence of a cycle slip of the carrier phase loop, the state noise on the ambiguities is zero. To account for the risk of cycle slip (non-linear and non-Gaussian model), the smoothing time constant of the filter, which naturally tends towards infinity, is limited. Indeed, if the time constant is too large, the effect of the cycle slip on the filtered pseudo-range lasts a long time, the time it takes for the filter to converge and recalibrate on the code measurement (without slip). In case of repeated cycle slips, at low signal-to-noise ratio, the slips will accumulate before the filter has time to converge on the code measurement, which can introduce an unacceptable measurement error. For example, five cycle slips give 1 meter of error.

To limit the time constant, a non-zero state noise value is used.

Optionally, a step Stp5 and/or Stp6 is then implemented by the calculation module of the receiver.

The step Stp5 of correcting tropospheric delays can then be applied to the pseudo-range measurement at the Kalman filter output for each satellite. This compensation is obtained by applying a classical model depending, among other things, on the time of day, the geographical position of the considered satellite.

The step Stp6 of correcting “system” errors can then be applied for each satellite axis. These errors are related to the GNSS principle. For example, it is the Sagnac Effect due to the time shift of receiving two signals rotating in opposite directions. Among these errors, there is also the imprecision of atomic clocks. During this step, the relativistic effect is also corrected. These corrections to be carried out are given by the considered satellite through a “navigation” message containing the corrective terms. These corrective terms are common to the four measurements from the same satellite.

According to an alternative embodiment, the steps of correcting tropospheric delays Stp5 and “system” errors Stp6 can be carried out upstream of the Kalman filtering provided these corrections are applied to the four pseudo-range measurements.

Still with the calculation instant tₙ, once these corrections thus carried out, if necessary, on the smoothed pseudo-range measurement, the calculation module estimates, in the step Stp7 and with reference to [FIG. 3] FIG. 3, the position of the geopositioning receiver by combining the smoothed (or corrected) pseudo-ranges calculated for each visible satellite of the receiver using the resolution algorithm, PVT for “Position, Velocity and Time” in Anglo-Saxon terminology and also taking into account the coefficient value p determined for each satellite at the step Stp4.

Consider that it has been calculated thus, for the processing instant tₙ and the i^{th} satellite, i=1 to N, the smoothed (and corrected) pseudo-range PR_{smoothed i} measurement, the coefficient ρᵢ.

As stated previously, at least four pseudo-ranges are necessary: therefore, N≥4.

In the considered embodiment, a differential case is used, which allows the problem to be solved by linearizing, by considering the differences between the positioning point to be determined and a predetermined point, called linearization point P0 of known coordinates (x₀, y₀, z₀, t₀).

In this step Stp7, the calculation module solves the following equation:

$${Z}_{sat} = {H}_{pos sat} \cdot {X}_{pos}$$

$$The matrix {H}_{pos sat} linking {Z}_{sat} to {X}_{pos} is [ \begin{matrix}cos {θ}_{x 1} & cos {θ}_{y 1} & cos {θ}_{z 1} & 1 & {ρ}_{1} \\ cos {θ}_{x 2} & cos {θ}_{y 2} & cos {θ}_{z 2} & 1 & {ρ}_{2} \\ ⋮ & ⋮ & ⋮ & \vert & ⋮ \\ cos {θ}_{xN} & cos {θ}_{yN} & cos {θ}_{zN} & 1 & {ρ}_{N}\end{matrix} ]$$

Where (cos θₓᵢ, cos θ_{yi}, cos θ_{zi}): direction cosines in the direction of the i^{th} satellite.

In the system to be solved Zₛₐₜ=H_{pos sat}·Xₚₒₛ, is considered:

$${X}_{pos} = [ \begin{matrix}Δ x \\ Δ y \\ Δ z \\ Δ t \\ {Δ}_{TPG}\end{matrix} ] = [ \begin{matrix}x - {x}_{0} \\ y - {y}_{0} \\ z - {z}_{0} \\ t - {t}_{0} \\ {Δ}_{TPG}\end{matrix} ]$$

$${Z}_{sat} = [ \begin{matrix}Δ P {R}_{smoothed 1} \\ Δ P {R}_{smoothed 2} \\ ⋮ \\ Δ P {R}_{smoothed N}\end{matrix} ]$$

such that ΔPR_{smoothed i}=PR_{smoothed i}−Distance calculatedᵢ
where:

$$Distance {calculated}_{i} = \sqrt{{( {x}_{0} - {x}_{sat i} )}^{2} + {( {y}_{0} - {y}_{sat i} )}^{2} + {( {z}_{0} - {z}_{sat i} )}^{2}}$$

and (x_{sat i}, y_{sat i}, z_{sat i}): position of satellite i (known thanks to the ephemerides)
H_{pos sat} is always equal to

$$[ \begin{matrix}cos {θ}_{x 1} & cos {θ}_{y 1} & cos {θ}_{z 1} & 1 & {ρ}_{1} \\ cos {θ}_{x 2} & cos {θ}_{y 2} & cos {θ}_{z 2} & 1 & {ρ}_{2} \\ ⋮ & ⋮ & ⋮ & \vert & ⋮ \\ cos {θ}_{xN} & cos {θ}_{yN} & cos {θ}_{zN} & 1 & {ρ}_{N}\end{matrix} ]$$

The solution to the problem is given by the least squares method:

$${\hat{X}}_{pos} = {( {H}_{pos sat}^{t} \cdot {H}_{pos sat} )}^{- 1} \cdot {H}_{pos sat}^{t} \cdot {Z}_{sat}$$

The consideration of coefficients ρ₁ . . . ρ_{N} allows to solve the position with the smoothed code pseudo-range measurements of all tracked satellites, from the moment a code measurement on at least one of the two frequencies is available.

In one embodiment, prior to the step Stp7, when the linearization point P0, assumed to be close enough to the real position for linearization errors to be negligible, is not known, the latter is determined, for example, from the four pseudo-ranges, as known in the state of the art, for example by a non-linear resolution method such as the Bancroft type or by iterative resolution.

The invention thus allows to mix single-frequency and dual-frequency measurements, smoothed by a Kalman filter while taking into account the impact of this mixing on the propagation time difference between the two frequencies in a reliable and simple manner.

Indeed, the effect of the Δ_{TPG} on the output of the dual-frequency code carrier smoothing filter cannot be predicted without taking into account the measurement history, which may have been mixed. Only a calculation based on the filter gains allows to reliably and simply estimate the effect of Δ_{TPG}.

In one embodiment, the calculation module may comprise at least one (micro) processor and at least one memory, in which a computer program, also called a computer program product, comprising software instructions are stored. When executed on the calculation module microprocessor, the steps incumbent on the latter are then implemented. The computer program is also able to be recorded on a medium, not represented, readable by a computer. The computer-readable medium is, for example, a medium capable of storing electronic instructions and being coupled to a bus of a computer system. For example, the readable medium is an optical disk, a magneto-optical disk, a ROM memory, a RAM memory, any type of non-volatile memory (for example, FLASH or NVRAM), or a magnetic card. On the readable medium is then stored a computer program comprising software instructions.

Alternatively, the calculation module is implemented as a programmable logic component, such as an FPGA (Field Programmable Gate Array), or an integrated circuit, such as an ASIC (Application Specific Integrated Circuit).

1. A method for satellite geopositioning implemented by a geopositioning terminal from N satellites, with N≥4, each emitting electromagnetic geopositioning signals, called dual-frequency, on two different frequencies Fa, Fb, each of said signals being formed of a carrier frequency modulated by a spreading code, said terminal comprising at least one reception module configured to receive electromagnetic signals coming from each satellite on two different frequencies and at least one calculation module configured to process said signals, said method comprising, for each geopositioning satellite, for each considered instant of a succession of considered instants of determining the position of the geopositioning terminal:
a calculation step, in nominal mode, of four pseudo-ranges, a pseudo-range being calculated from each element from among the two codes and the two carriers of the received dual-frequency geopositioning signals;
a step of correcting ionospheric delays on each calculated pseudo-range by applying an ionospheric error propagation model;
a step of code carrier smoothing using a Kalman filter the measurement vector of which comprises the four corrected pseudo-ranges and the state vector of which comprises a single smoothed pseudo-range measurement, said carrier smoothing step using a Kalman filter having the function of correcting measurement noise residual ionospheric error and comprising two steps successively implemented on the state vector, to provide in the state vector, thus propagated and recalibrated, a single smoothed pseudo-range:
one of the two steps being a propagation step, as a function of a propagation matrix; and
the other of the two steps being a recalibration step, as a function of said measurement vector and a recalibration gain matrix;
the position of the geopositioning terminal being estimated using the smoothed pseudo-ranges calculated for each satellite;
said propagation matrix being also used to propagate another vector, called a fictitious state vector, of the same size as the state vector, said propagated fictitious state vector being also recalibrated as a function of said recalibration gain matrix and a fictitious measurement vector of the same size as said measurement vector and including components of predefined constant values, common to said determination instants;
a coefficient, called proportionality constant, indicating the ratio between a propagation difference between the two frequencies in the terminal and the bias induced by said difference on said smoothed pseudo-range is determined as a function of the component of the fictitious state vector of the same rank as the rank of the smoothed pseudo-range in the state vector;
the position of the geopositioning terminal is estimated as a function of said N smoothed pseudo-ranges for the N satellites and the N proportionality constants determined for the N satellites.

2. The method according to claim 1, wherein, if the propagation time reference corresponds to the frequency Fa, the proportionality constant is determined as the result of the ratio between, on the one hand, the component of the fictitious state vector of the same rank as the rank of the smoothed pseudo-range in the state vector and, on the other hand, the component of the fictitious measurement vector of the same rank as the rank, in the measurement vector, of the code pseudo-range for the frequency Fb.

3. The method according to claim 1, wherein the component of the fictitious measurement vector of the same rank as the rank, in the measurement vector, of the code pseudo-range for the frequency Fa, is set to 0.

4. The method according to claim 1, wherein the two components of the fictitious measurement vector of the same ranks as those in the measurement vector, of the code and carrier pseudo-ranges for the frequency Fb are set to 1, the other two being set to 0.

5. The method according to claim 1, wherein if the pseudo-ranges of one of the two frequencies of the measurement vector are not available during a time interval, a corresponding reduction in the dimension of the observation model implemented by the Kalman filter is carried out during said interval, said reduction comprising a reduction in the number of components of each of the vectors from among said measurement vector and said fictitious measurement vector.

6. The method according to claim 1, wherein the position of the geopositioning terminal is estimated by solving the system
$${Z}_{sat} = {H}_{pos sat} \cdot {X}_{pos}$$
where each component of the vector Xₚₒₛ is a function of a respective unknown from among the position unknowns to be determined x, y, z, t, Δ_{TPG}
the i^{th} component of the vector Zₛₐₜ i=1 to N is a function of the smoothed pseudo-range calculated for the i^{th} satellite
where if (cos θₓᵢ, cos θ_{yi}, cos θ_{zi}) are the direction cosines in the direction of the i^{th} satellite and ρᵢ is the proportionality constant calculated for the i^{th} satellite for the considered instant, the i^{th} line of H_{pos sat} includes the components cos θₓᵢ, cos θ_{yi}, cos θ_{zi}, a constant and ρᵢ.

7. A non-transitory computer-readable medium including a computer program including software instructions which, when executed by a computer, implement a method for satellite geopositioning according to claim 1.

8. A geopositioning terminal comprising at least one reception module configured to receive electromagnetic geopositioning signals, called dual-frequency, emitted by at least four satellites on two different frequencies and at least one calculation module configured to process said geopositioning signals and implement the method for geopositioning according to claim 1.
